(19) United States
(12) Patent Application Publication
(10) Pub. No.: US 2025/0119088 A1
(43) Pub. Date: Apr. 10, 2025

(54) DEVICE AND METHOD FOR SUPPLYING POWER

(71) Applicant: HL MANDO CORPORATION, Gyeonggi-do (KR)

(72) Inventors: Beomhee JANG, Gyeonggi-do (KR); Sumin LEE, Gyeonggi-do (KR)

(21) Appl. No.: 18/784,909

(22) Filed: Jul. 25, 2024

(30) Foreign Application Priority Data
Oct. 10, 2023 (KR) 10-2023-0134114

(51) Int. Cl. H02P 27/06

(52) U.S. Cl. CPC H02P 27/06

(57) ABSTRACT

A power supply device and method improve space utilization and reduce power consumption and costs by implementing a voltage doubler based on the voltage of input power and driving a switching unit to thereby optimize leakage current. The power supply device comprises: a first power converter modulating a first voltage of a power source and converting a frequency of the first voltage to output a second voltage lower than the first voltage; a second power converter converting a frequency of the second voltage to output a third voltage lower than the second voltage and a fourth voltage between the first voltage and the third voltage; a controller receiving the third voltage; a switch drive outputting a fifth voltage higher than the first voltage using the first and fourth voltages; and a switch unit controlling connection between the power source and a motor in response to the fifth voltage.

### CROSS-REFERENCE TO RELATED APPLICATION

This application claims priority to and benefit from Korean Patent Application No. 10-2023-0134114, filed on Oct. 10, 2023, which is hereby incorporated by reference for all purposes as if fully set forth herein.

### BACKGROUND

### Field

Embodiments of the present disclosure generally relate to a power supply device and method for controlling power supplied according to a switching operation.

### Description of Related Art

A power supply device of a vehicle is a power system for operating electronic components in the vehicle. For example, the power supply device may supply 12V direct current voltage to operate the electronic components of the vehicle.

In recent years, however, power systems that supply 48V direct current voltage are provided to increase energy capacity and enhance power efficiency.

Accordingly, application of a power system supplying higher voltage such as 48V DC voltage may require replacement of all conventional electronic components operated at lower voltage (for example, 12V DC-operated vehicle electronic components) with other electric components operated at higher voltage such as 48V electronic components and, if not properly controlled, the circuitry in the system may be damaged.

Thus, a configuration of a voltage limiting circuit may be needed not to exceed maximum allowable voltage, which may lead to an increase in size and resultantly deteriorate space utilization while increasing costs.

Further, if the voltage limiting circuit is configured, the supplied voltage increases, causing leakage current, with the result of increasing power consumption.

### SUMMARY

Some embodiments of the present disclosure may provide a power supply device and method capable of increasing space utilization and reducing costs and power consumption.

In an aspect, present embodiments of the present disclosure may provide a power supply device, comprising a first power converter receiving and modulating a first voltage V1 output from a power unit, and converting a frequency of the first voltage V1 to generate and output a second voltage V2 lower than the first voltage V1, a second power converter receiving the second voltage V2 output from the first power converter and converting a frequency of the second voltage V2 to generate and output a third voltage V3 lower than the second voltage V2 and a fourth voltage V4 lower than the first voltage V1 and higher than the third voltage V3, a controller receiving the third voltage V3 output from the second power converter to operate, a switching driving unit generating a fifth voltage V5 higher than the first voltage V1 using the first voltage V1 output from the power unit and the fourth voltage V4 output from the second power converter and outputting the generated fifth voltage V5 according to a control signal of the controller, and a switching unit positioned between the power unit and a motor and controlling connection between the power unit and the motor based on the fifth voltage V5 output from the switching driving unit.

Further, the switching unit according to certain embodiments may include a back-to-back switch that is turned on if the fifth voltage V5 output from the switching driving unit is supplied to a gate terminal to supply the first voltage V1 output from the power unit to the motor.

Further, the first power converter according to some embodiments may generate and output the second voltage V2 within a preset voltage range. The back-to-back switch may be turned on when the fifth voltage V5 generated based on the second voltage V2 is a preset reference voltage or more.

Further, the switching driving unit according to certain embodiments may include a first voltage input unit receiving the first voltage V1 output from the power unit, a second voltage input unit receiving the fourth voltage V4 output from the second power converter, a voltage generation unit generating the fifth voltage V5 higher than the first voltage V1 using the first voltage V1 received from the first voltage input unit and the fourth voltage V4 received from the second voltage input unit, and a voltage output unit outputting the generated fifth voltage V5 according to the control signal of the controller.

Further, the switching driving unit according to some embodiments may further include a first backflow prevention unit positioned between the first voltage input unit and the voltage generation unit to prevent a backflow of the fifth voltage V5 generated by the voltage generation unit.

Further, the switching driving unit according to certain embodiments may further include a voltage charging unit positioned between the second voltage input unit and the voltage generation unit to charge the fifth voltage V5 generated by the voltage generation unit.

Further, the switching driving unit according to some embodiments may further include a second backflow prevention unit positioned between the voltage generation unit and the voltage output unit to prevent a backflow of the fifth voltage V5 input to the voltage output unit.

Further, the switching driving unit according to certain embodiments may further include a voltage rectification unit positioned between the second backflow prevention unit and the voltage output unit to rectify the fifth voltage V5 generated by the voltage generation unit and supply the fifth voltage V5 to the voltage output unit.

Further, the voltage output unit according to some embodiments may include a first output unit outputting the generated fifth voltage V5 according to the control signal of the controller. The back-to-back switch may include a first switching element that is turned on if the fifth voltage V5 output from the first output unit is supplied to the gate terminal.

Further, the voltage output unit according to certain embodiments may include a second output unit outputting the generated fifth voltage V5 according to the control signal of the controller. The back-to-back switch may include a second switching element that is turned on if the fifth voltage V5 output from the second output unit is supplied to the gate terminal.

Further, the first power converter according to some embodiments may include a buck converter modulating the first voltage V1 output as a direct current DC voltage into a positive pulse wave through a switching-type regulator and performing frequency conversion to convert into the second voltage V2 lower than the first voltage V1.

Further, the second power converter according to certain embodiments may include a buck converter converting the second voltage V2 output as a DC voltage into the third voltage V3 lower than the second voltage V2 through a switching-type regulator.

Further, the second power converter according to some embodiments may include a boost converter converting the third voltage V3 output as a DC voltage into the fourth voltage V4 lower than the first voltage V1 and higher than the third voltage V3 through a switching-type regulator.

Further, certain embodiments may further include an inverter positioned between the switching unit and the motor to convert a voltage output from the switching unit and supplying the converted voltage to the motor.

Further, the controller according to some embodiments may detect at least one of an operation state for the inverter and an operation state for the motor, generate a control signal according to a result of the detection, and output the control signal to the switching driving unit.

In another aspect, certain embodiments may provide a power supply method comprising a first step of receiving and modulating a first voltage V1 output from a power unit, and converting a frequency of the first voltage V1 to generate and output a second voltage V2 lower than the first voltage V1, by a first power converter, a second step of receiving the second voltage V2 output from the first power converter, and converting a frequency of the second voltage V2 to generate and output a third voltage V3 lower than the second voltage V2 and a fourth voltage V4 lower than the first voltage V1 and higher than the third voltage V3, by a second power converter, a third step of receiving the third voltage V3 output from the second power converter to operate, by a controller, a fourth step of generating a fifth voltage V5 higher than the first voltage V1 using the first voltage V1 output from the power unit and the fourth voltage V4 output from the second power converter and outputting the generated fifth voltage V5 according to a control signal of the controller, by a switching driving unit, and a fifth step of controlling connection between the power unit and the motor based on the fifth voltage V5 output from the switching driving unit, by a switching unit positioned between the power unit and a motor.

Further, the switching unit according to some embodiments may include a back-to-back switch that is turned on if the fifth voltage V5 output from the switching driving unit is supplied to a gate terminal to supply the first voltage V1 output from the power unit to the motor.

Further, in the first step according to certain embodiments, the first power converter may generate and output the second voltage V2 within a preset voltage range, and in the fifth step, the back-to-back switch of the switching unit may be turned on when the fifth voltage V5 generated based on the second voltage V2 is a preset reference voltage or more.

Further, in the fourth step according to some embodiments, a voltage generation unit may generate the fifth voltage V5 higher than the first voltage V1 using the first voltage V1 received from a first voltage input unit and the fourth voltage V4 received from a second voltage input unit, and a first output unit outputs the generated fifth voltage V5 according to the control signal of the controller, and in the fifth step, a first switching element of the back-to-back switch may be turned on if the fifth voltage V5 output from the first output unit is supplied to the gate terminal.

Further, in the fourth step according to certain embodiments, the voltage generation unit may generate the fifth voltage V5 higher than the first voltage V1 using the first voltage V1 received from the first voltage input unit and the fourth voltage V4 received from the second voltage input unit, and a second output unit may output the generated fifth voltage V5 according to the control signal of the controller, and in the fifth step, a second switching element of the back-to-back switch may be turned on if the fifth voltage V5 output from the second output unit is supplied to the gate terminal.

According to some embodiments of the present disclosure, there may be provided a power supply device and method that may improve space utilization and reduce power consumption and costs by implementing a voltage doubler based on the voltage of input power without using a separate dedicated IC (predriver IC), and driving a switch unit to optimize leakage current.

In addition, according to certain embodiments of the present disclosure, there may be provided a power supply device and method capable of preventing damage to electronic components by performing the cut off function of a power unit to prevent overcurrent.

### BRIEF DESCRIPTION OF DRAWINGS

The above and other objects, features, and advantages of the disclosure will be more clearly understood from the following detailed description, taken in conjunction with the accompanying drawings, in which:

FIG. 1 is a block diagram illustrating a power supply device according to an embodiment of the present disclosure;

FIG. 2 is a block diagram illustrating a switching driving unit according to an embodiment of the present disclosure;

FIG. 3 is a circuit diagram illustrating a power supply device according to an embodiment of the present disclosure; and

FIG. 4 is a flowchart illustrating a power supply method according to an embodiment of the present disclosure.

### DETAILED DESCRIPTION OF EXEMPLARY EMBODIMENTS

In the following description of examples or embodiments of the disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the disclosure, detailed descriptions of well-known functions and components incorporated herein will be omitted when it is determined that the description may make the subject matter in some embodiments of the disclosure rather unclear. The terms such “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

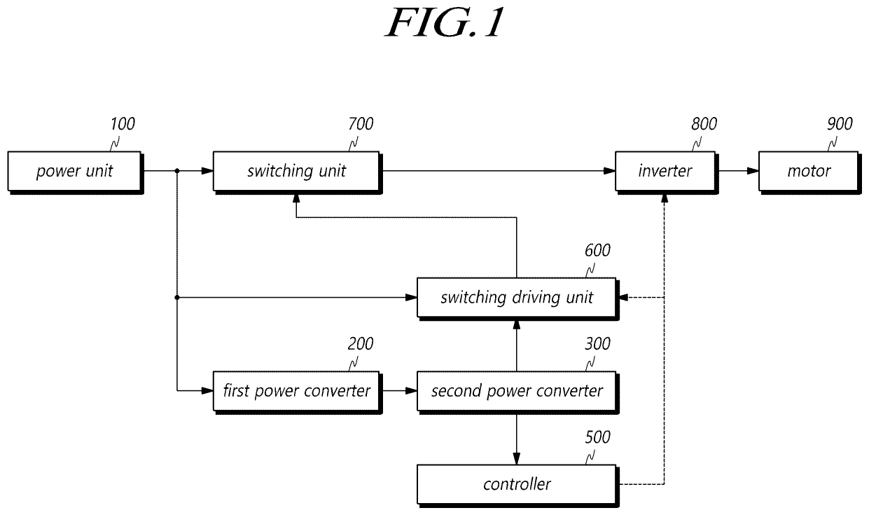

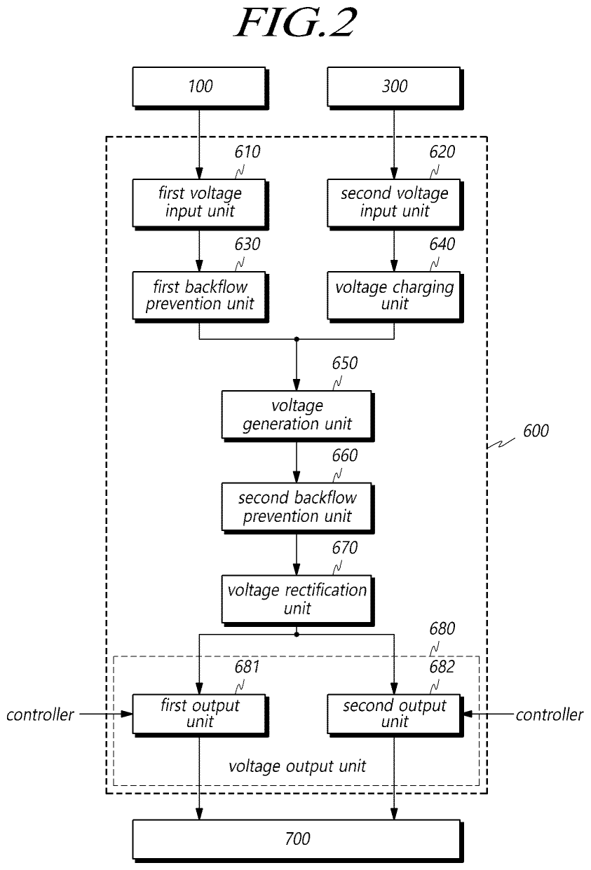

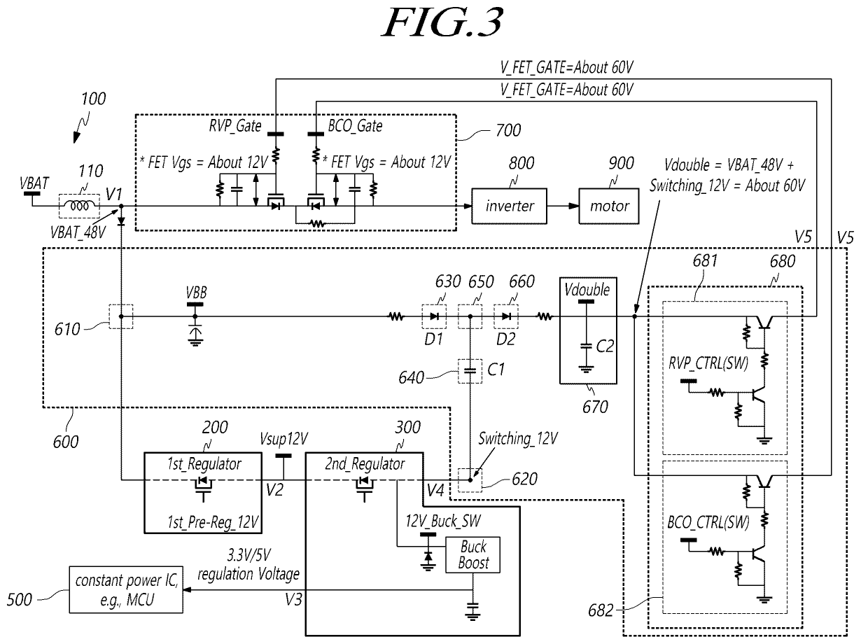

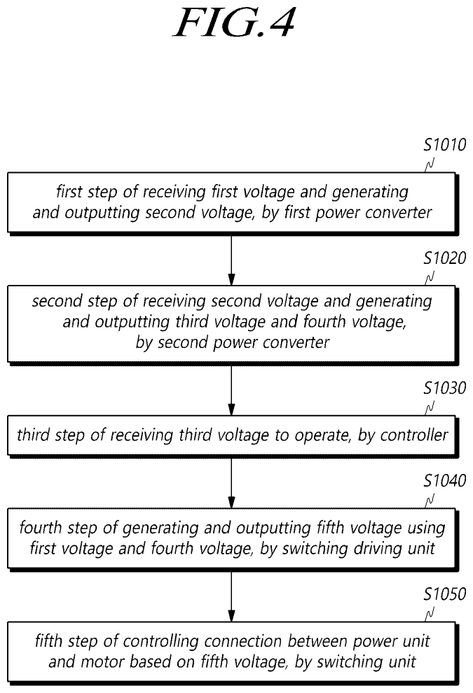

FIG. 1 is a block diagram illustrating a power supply device according to an embodiment of the present disclosure. FIG. 2 is a block diagram illustrating a switching driving unit according to an embodiment of the present disclosure. FIG. 3 is a circuit diagram: illustrating a power supply device according to an embodiment of the present disclosure. FIG. 4 is a flowchart illustrating a power supply method according to an embodiment of the present disclosure.

Referring to FIGS. 1 to 3, a power supply device may include a power unit 100, a first power converter 200, a second power converter 300, a controller 500, a switching driving unit or switch drive 600, a switching unit or switch unit 700, and an inverter 800.

The first power converter 200 may be configured to receive a first voltage V1 output from the power unit 100, modulate the first voltage V1, convert a frequency of the first voltage V1 to generate a second voltage V2, and output the second voltage V2. The second power converter 300 may be configured to receive the second voltage V2 output from the first power converter 200, convert a frequency of the second voltage V2 to generate a third voltage V3 lower than the second voltage V2 and a fourth voltage V4 lower than the first voltage V1 and higher than the third voltage V3, and output the third voltage V3 and the fourth voltage V4. The controller 500 may be configured to receive the third voltage V3 output from the second power converter 300. The switching driving unit 600 may be configured to generate a fifth voltage V5 higher than the first voltage V1 using the first voltage V1 output from the power unit 100 and the fourth voltage V4 output from the second power converter 300 and output the generated fifth voltage V5 according to a control signal of the controller 500. The switching unit 700 may be positioned or connected between the power unit 100 and a motor 900 and be configured to control connection between the power unit 100 and the motor 900 based on the fifth voltage V5 output from the switching driving unit 600.

The power unit 100 may include a power source of at least one of direct current (DC) voltage and alternating current (AC) voltage. The power unit 100 may supply the first voltage V1 to the first power converter 200, the switching driving unit 600, and the inverter 800.

In the exemplary embodiment, the first voltage V1 may be a DC voltage, and the DC voltage may be battery power, although not required. The first voltage V1 include any power source that may supply DC voltage.

For example, the power unit 100 may generate and output a 48V DC voltage as the first voltage V1 by the battery.

A filter 110 may receive the voltage from the battery of the power unit 100 and filter the received voltage to output the filtered first voltage V1.

The filter 110 may include, for example, but not limited to, one or more of reactors, capacitors, and the like.

The first power converter 200 may receive the first voltage V1 output from the power unit 100 and modulate the received first voltage V1, and convert the frequency of the first voltage V1 to generate and output a second voltage V2 lower than the first voltage V1.

The first power converter 200 may be connected to the power unit 100 and may receive the first voltage V1 output from the power unit 100.

In this case, the first power converter 200 may receive a DC voltage from the power unit 100.

The first power converter 200 may modulate the first voltage V1 supplied from the power unit 100 and convert the frequency of the first voltage V1 to generate the second voltage V2 lower than the first voltage V1.

For instance, the first power converter 200 may modulate the DC voltage, which is the first voltage V1 supplied from the power unit 100, into a pulse wave, and convert the frequency of the modulated DC voltage to generate and output the second voltage V2 lower than the first voltage V1.

Here, the pulse wave may include, for example, but not limited to, a positive pulse wave.

The first power converter 200 may include a DC-DC converter. For example, the first power converter 200 may include a buck converter and a boost converter. However, the first power converter 200 may not be limited thereto, and the first power converter 200 may include any converter configured to drop the received DC voltage into a DC voltage lower than the received DC voltage.

The first power converter 200 according to an embodiment of the present disclosure may include a buck converter configured to modulate the first voltage V1 output as a DC voltage into a positive pulse wave and convert the first voltage V1 into the second voltage V2 lower than the first voltage V1 through a switching-type regulator.

In an exemplary embodiment of the present disclosure, the buck converter may modulate the DC voltage supplied from the power unit 100 to a positive pulse wave through a switching-type regulator, and convert the frequency of the DC voltage to generate the second voltage V2 lower than the first voltage V1.

For example, the first power converter 200 may modulate the 48V DC voltage, which is the first voltage V1 supplied from the power unit 100, into a pulse wave, convert the frequency of the first voltage V1, and generate and output a 12V DC voltage, which is the second voltage V2, lower than the first voltage V1.

In this case, the first power converter 200 may be configured to generate and output the second voltage V2 within a preset voltage range, and generate and output a DC voltage of 20 V or less as the second voltage V2.

The preset voltage range may be set to a voltage range greater than 10 V and smaller than 18 V.

The second power converter 300 may receive the second voltage V2 output from the first power converter 200 and convert the frequency of the second voltage V2 to generate and output a third voltage V3 lower than the second voltage V2 and a fourth voltage V4 lower than the first voltage V1 and higher than the third voltage V3.

The second power converter 300 may be connected to the first power converter 200 and may receive the second voltage V2 output from the first power converter 200.

In this case, the second power converter 300 may receive the second voltage V2 modulated into the positive pulse wave from the first power converter 200.

The second power converter 300 may convert the frequency of the second voltage V2 supplied from the first power converter 200 to generate a third voltage V3 lower than the second voltage V2.

Further, the second power converter 300 may convert the frequency of the third voltage V3 to generate a fourth voltage V4 lower than the first voltage V1 and higher than the third voltage V3.

In this case, the second power converter 300 may convert the frequency of the second voltage V2 supplied from the first power converter 200 to generate the fourth voltage V4 lower than the first voltage V1 and higher than the third voltage V3.

The second power converter 300 may include, for instance, but not limited to, a DC-DC converter. For example, the second power converter 300 may include a buck converter and a boost converter. However, the present disclosure is not limited thereto, and the second power converter 300 may include any converter configured to drop the received DC voltage into a DC voltage lower than the received DC voltage or boost the decreased DC voltage into a higher DC voltage.

The second power converter 300 according to an exemplary embodiment of the present disclosure may include a buck converter configured to convert the second voltage V2 output as a DC voltage to a third voltage V3 lower than the second voltage V2 through a switching-type regulator.

Further, the second power converter 300 according to an exemplary embodiment of the present disclosure may include a boost converter configured to convert the third voltage V3 output as a DC voltage to the fourth voltage V4 lower than the first voltage V1 and higher than the third voltage V3 through a switching-type regulator.

In other words, the buck converter may convert the frequency of the second voltage V2 modulated into a positive pulse wave in the first power converter 200 and generate and output the third voltage V3 lower than the second voltage V2.

The boost converter may generate and output the fourth voltage V4 lower than the first voltage V1 and higher than the third voltage V3 using the generated third voltage V3.

For example, the second power converter 300 may drop the 12V DC voltage, which is the second voltage V2 supplied from the first power converter 200, and generate and output a 5V or 3.3V DC voltage, lower than the second voltage V2, as the third voltage V3.

The second power converter 300 may boost the DC voltage of 5V or 3.3V, which is the generated third voltage V3, and generate and output the DC voltage of 12V, which is lower than the first voltage V1 and higher than the third voltage V3, as the fourth voltage V4.

In this case, the second power converter 300 may output the 12V DC voltage generated by the first power converter 200 as the fourth voltage V4.

The controller 500 may receive the third voltage V3 output from the second power converter 300 to operate.

The controller 500 may be connected to the second power converter 300 and may receive the third voltage V3 output from the second power converter 300 to operate.

For example, the controller 500 may receive a DC voltage of 5V or 3.3V, which is the third voltage V3 generated by the second power converter 300, to operate.

Here, the controller 500 may be connected to the power unit 100, the first power converter 200, the second power converter 300, driving unit 600, the switching unit 700, the switching inverter 800, and the motor 900 to control and monitor their operations.

The switching driving unit or switch drive 600 may generate a fifth voltage V5, higher than the first voltage V1, using the first voltage V1 output from the power unit 100 and the fourth voltage V4 output from the second power converter 300, and output the generated fifth voltage V5 according to the control signal of the controller 500.

The switching driving unit 600 may be connected to the power unit 100 and may receive the first voltage V1 output from the power unit 100.

The switching driving unit 600 may be connected to the second power converter 300 and may receive the fourth voltage V4 output from the second power converter 300.

In other words, the switching driving unit 600 may receive the first voltage V1 output as a DC voltage from the power unit 100, and may receive the fourth voltage V4, converted into a positive pulse wave, from the second power converter 300.

The switching driving unit 600 may generate the fifth voltage V5, higher than the first voltage V1, using the first voltage V1 supplied from the power unit 100 and the fourth voltage V4 supplied from the second power converter 300.

More specifically, the switching driving unit 600 may generate and output the fifth voltage V5 higher than the first voltage V1 by summing the first voltage V1 supplied from the power unit 100 as a DC voltage and the fourth voltage V4 supplied from the second power converter 300 as a positive pulse wave.

The switching driving unit 600 may be connected to the controller 500 and output the generated fifth voltage V5 according to the control signal of the controller 500.

For example, the switching driving unit 600 may generate and output a 60V DC voltage, which is the fifth voltage V5 higher than the first voltage V1, by summing the 48V DC voltage which is the first voltage V1 supplied from the power unit 100 and the 12V DC voltage which is the fourth voltage V4 supplied from the second power converter 300.

The switching driving unit 600 according to an embodiment of the present disclosure may include a first voltage input unit 610, a second voltage input unit 620, a voltage generation unit 650, a voltage output unit 680, a first backflow prevention unit 630, a voltage charging unit 640, a second backflow prevention unit 660, and a voltage rectification unit or voltage rectifier 670. The first voltage input unit 610 may be configured to receive the first voltage V1 output from the power unit 100. The second voltage input unit 620 may be configured to receive the fourth voltage V4 output from the second power converter 300. The voltage generation unit 650 may be configured to generate the fifth voltage V5, higher than the first voltage V1, using the first voltage V1 received from the first voltage input unit 610 and the fourth voltage V4 received from the second voltage input unit 620. The voltage output unit 680 may be configured to output the generated fifth voltage V5 according to the control signal of the controller 500. The first backflow prevention unit 630 may be connected between the first voltage input unit 610 and the voltage generation unit 650 to prevent a backflow of the fifth voltage V5 generated by the voltage generation unit 650. The voltage charging unit 640 may be connected between the second voltage input unit 620 and the voltage generation unit 650 to charge the fifth voltage V5 generated by the voltage generation unit 650. The second backflow prevention unit 660 may be connected between the voltage generation unit 650 and the voltage output unit 680 to prevent a backflow of the fifth voltage V5 input to the voltage output unit 680. The voltage rectification unit 670 may be connected between the second backflow prevention unit 660 and the voltage output unit 680 to rectify the fifth voltage V5 generated by the voltage generation unit 650 and supply the fifth voltage V5 to the voltage output unit 680.

The first voltage input unit or node 610 may receive a first voltage V1 output from the power unit 100, and the second voltage input unit or node 620 may receive a fourth voltage V4 output from the second power converter 300.

The first voltage input unit or node 610 may be connected to an output terminal of the power unit 100, an input terminal of the first power converter 200, and an input terminal of the switching unit 700, and may receive the first voltage V1 output as a DC voltage from the power unit 100.

The second voltage input unit or node 620 may be connected to an output terminal of the second power converter 300 and may receive a fourth voltage V4 converted into a positive pulse wave from the second power converter 300.

The voltage generation unit (or node) or voltage generator 650 may generate a fifth voltage V5 higher than the first voltage V1 using the first voltage V1 supplied from the first voltage input unit 610 and the fourth voltage V4 supplied from the second voltage input unit 620.

The voltage output unit 680 may output the generated fifth voltage V5 according to the control signal of the controller 500.

The voltage generation unit 650 may generate and output the fifth voltage V5 higher than the first voltage V1 by summing the first voltage V1 supplied from the first voltage input unit 610 as a DC voltage and the fourth voltage V4 supplied from the second voltage input unit 620 as a positive pulse wave.

The voltage output unit 680 may be connected to the controller 500 and output the generated fifth voltage V5 according to the control signal of the controller 500.

For example, the voltage generation unit or node 650 may generate and output a 60V DC voltage which is the fifth voltage V5 higher than the first voltage V1 by summing the 48V DC voltage, which is the first voltage V1 supplied from the first voltage input unit 610, and the 12V DC voltage, which is the fourth voltage V4 supplied from the second voltage input unit 620.

The first backflow prevention unit 630 may be connected between the first voltage input unit 610 and the voltage generation unit 650, and may be configured to prevent backflow of the fifth voltage V5 generated by the voltage generation unit 650.

The first backflow prevention unit 630 may include a one-way voltage or switch configured to conduct current primarily in one direction (asymmetric conductance), such as a diode D1. The first backflow prevention unit 630 may be configured to block the fifth voltage V5 generated by the voltage generation unit 650 so that the fifth voltage V5 generated by the voltage generation unit 650 cannot flow back to the first voltage input unit 610.

The voltage charging unit or voltage charger 640 may be connected between the second voltage input unit 620 and the voltage generation unit 650, and may charge the fifth voltage V5 generated by the voltage generation unit 650.

For example, the voltage charging unit 640 may include a capacitor C1, and may generate the charged fifth voltage V5 by charging the fifth voltage V5 generated by the voltage generation unit 650 through a charge pump.

The second backflow prevention unit 660 may be connected between the voltage generation unit 650 and the voltage output unit 680. The second backflow prevention unit 660 may be configured to prevent backflow of the fifth voltage V5 input to the voltage output unit 680.

The second backflow prevention unit 660 may include a one-way voltage or switch configured to conduct current primarily in one direction (asymmetric conductance), such as a diode D2. The second backflow prevention unit 660 may be configured to block the fifth voltage V5 input to the voltage output unit 680 so that the fifth voltage V5 input to the voltage output unit 680 cannot flow back to the voltage generation unit 650.

In an exemplary embodiment of the present disclosure, the second backflow prevention unit 660 may be connected between the voltage generation unit 650 and the voltage rectification unit 670, and may be configured to prevent backflow of the fifth voltage V5 input to the voltage rectification unit 670.

The second backflow prevention unit 660 may be configured to block the fifth voltage V5 rectified by the voltage rectification unit 670 so that the fifth voltage V5 rectified by the voltage rectification unit 670 cannot flow back to the voltage generation unit 650.

The voltage rectification unit or voltage rectifier 670 may be connected between the second backflow prevention unit 660 and the voltage output unit 680, and may be configured to rectify the fifth voltage V5 generated by the voltage generation unit 650 and supply the rectified fifth voltage V5 to the voltage output unit 680.

The voltage rectification unit 670 may include a capacitor C2, and may be configured to rectify the fifth voltage V5 generated by the voltage generation unit 650 to generate the rectified fifth voltage V5 and supply the rectified fifth voltage V5 to the voltage output unit 680.

The switching or switch unit 700 may be connected between the power unit 100 and the inverter 800 or the motor 900, and may be configured to control the connection between the power unit 100 and the inverter 800 or the motor 900 based on the fifth voltage V5 output from the switching driving unit 600.

The switching unit or switch unit 700 may include one or more transistors. The transistor of the switch unit 710 may include an input terminal, an output terminal, and a control terminal.

Here, the input terminal may be connected to the power unit 100, the output terminal may be connected to the inverter 800 or the motor 900, and the control terminal may be connected to the switching driving unit 600.

In this case, in response to a voltage at the control terminal greater than a voltage at the input terminal, the input terminal and the output terminal may be connected to each other.

Accordingly, the control terminal may be the gate terminal of the transistor, and the input terminal and the output terminal may be the source terminal or the drain terminal of the transistor.

For example, such a transistor may include a field effect transistor (FET). However, the present disclosure is not limited thereto, and the transistor of the switch unit 710 may include any transistor in which the input terminal and the output terminal may be connected to each other in response to a voltage at the control terminal greater than a voltage at the input terminal.

Further, the switching unit 700 may include a back-to-back switch configured to be turned on if the fifth voltage V5 output from the switching driving unit 600 is supplied to the gate terminal of the back-to-back switch to supply the first voltage V1 output from the power unit 100 to the motor 900.

For instance, the back-to-back switch may include a back-to-back field effect transistor FET.

The back-to-back switch may be turned on when the fifth voltage V5 generated based on the second voltage V2 is greater than or equal to a preset reference voltage.

For example, the predetermined reference voltage of the fifth voltage V5 may be set to a 60V DC voltage generated by summing the 48V DC voltage, which is the first voltage V1 supplied from the power unit 100, and the 12V DC voltage which is the fourth voltage V4 supplied from the second power converter 300.

Specifically, when the first power converter 200 generates and outputs a 12V DC voltage which is the second voltage V2, and the switching driving unit 600 generates and outputs a 60V DC voltage which is the fifth voltage V5 based on the second voltage V2, the switching unit 700 may supply the first voltage V1 output from the power unit 100 to the inverter 800 as a voltage difference occurs between the 60V DC voltage which is the fifth voltage V5 supplied to the gate terminal of the back-to-back switch and the 48V DC voltage which is the first voltage V1 supplied from the power unit and the voltage at the gate terminal of the switching unit 700 thus is 12V greater than the threshold voltage.

In other words, when the voltage at the gate terminal of the switching unit 700 is greater than the voltage at the input terminal of the switching unit 700, the input terminal and the output terminal of the switching unit 700 may be connected to each other to supply the first voltage V1 output from the power unit 100 to the inverter 800.

Here, the voltage output unit 680 according to an exemplary embodiment of the present disclosure may include a first output unit 681. The first output unit 681 may be configured to output the generated fifth voltage V5 according to the control signal of the controller 500. The back-to-back switch may include a first switching or switch element configured to be turned on when the fifth voltage V5 output from the first output unit 681 is supplied to the gate terminal.

The voltage output unit 680 according to an embodiment of the present disclosure may include a second output unit 682. The second output unit 682 may be configured to output the generated fifth voltage V5 according to the control signal of the controller 500. The back-to-back switch may include a second switching or switch element configured to be turned on when the fifth voltage V5 output from the second output unit 682 is supplied to the gate terminal.

When a switch SW is turned on according to the control signal of the controller 500, the first output unit 681 may supply the fifth voltage V5 higher than the first voltage V1 of the power unit 100 to the gate terminal of the first switching element, and the first switching element may be turned on by receiving the fifth voltage V5.

Accordingly, a voltage (or current) path may be formed between the power unit 100 and the inverter 800 to drive the inverter 800 or the motor 900.

Meanwhile, when the switch SW is turned off according to the control signal of the controller 500, the first output unit 681 may block the fifth voltage V5 supplied to the gate terminal of the first switching element, and the first switching element may be turned off as the supplied voltage is lower than the preset reference voltage.

Accordingly, since a voltage (or current) path is not formed between the power unit 100 and the inverter 800, driving of the inverter 800 or the motor 900 may be stopped.

When the switch SW is turned on according to the control signal of the controller 500, the second output unit 682 may supply the fifth voltage V5, which is higher than the first voltage V1 of the power unit 100, to the gate terminal of the second switching element, and the second switching element may be turned on by receiving the fifth voltage V5.

Accordingly, a voltage (or current) path may be formed between the power unit 100 and the inverter 800 to drive the inverter 800 or the motor 900.

Meanwhile, when the switch SW is turned off according to the control signal of the controller 500, the second output unit 682 may block the fifth voltage V5 supplied to the gate terminal of the second switching element, and the second switching element may be turned off as the supplied voltage is lower than the preset reference voltage.

Accordingly, since a voltage (or current) path is not formed between the power unit 100 and the inverter 800, driving of the inverter 800 or the motor 900 may be stopped.

The first switching element and the second switching element may be connected between the power unit 100 and the motor 900, and if the fifth voltage V5 output from the switching driving unit 600 is supplied to the gate terminal of the switching unit 700, the first switching element and the second switching element may be turned on to supply the first voltage V1 output from the power unit 100 to the motor 900.

In this case, the first switching element and the second switching element may be simultaneously turned on or off according to the control signal of the controller 500, and each of the first switching element and the second switching element may be selectively turned on or off according to the control signal of the controller 500.

In this case, the back-to-back switch may be configured by a source pin back-to-back arrangement and a common gate control method or a drain pin back-to-back arrangement and an individual gate control method in the arrangement order of the RVP FET and the BCO FET.

An embodiment of the present disclosure may further include an inverter 800 connected between the switching unit 700 and the motor 900 to convert the voltage output and supplied from the switching unit 700 and supply the converted voltage to the motor 900.

The inverter 800 may include any converter configured to receive a DC voltage from a DC-AC converter and convert the DC voltage into an AC voltage.

The inverter 800 may be connected between the switching unit 700 and the motor 900, and may convert the voltage output and supplied from the switching unit 700 and supply the converted voltage to the motor 900.

Here, the motor 900 may be, for example, but not limited to, a steering motor included in a steering device of the vehicle. However, the motor 900 can be any motor included in the vehicle, such as a motor for an electro-mechanical brake system.

Accordingly, the controller 500 may detect at least one of the operation state of the inverter 800 and the operation state of the motor 900, generate a control signal according to the detected operation state of the inverter 800 and/or the motor 900, and output the control signal to the switching driving unit 600.

As an example, when at least one of the operation state value for the inverter 800 or the operation state value for the motor 900 corresponds to each preset normal operation state range as a result of detection, the controller 500 may generate a control signal according to the result of detection and output the control signal to the switching driving unit 600.

However, the controller 500 may not output the control signal to the switching driving unit 600 when at least one of the operation state value for the inverter 800 and the operation state value for the motor 900 is out of each preset normal operation state range.

Here, each preset normal operation state range may be set to one value, but not limited thereto, and may be set to a plurality of values or a range.

FIG. 4 is a flowchart illustrating a power supply method according to an embodiment of the present disclosure.

The power supply method according to an embodiment of the present disclosure may include step S1010 of receiving a first voltage V1 output from the power unit or power source 100, modulating the first voltage V1, converting a frequency of the first voltage V1 to generate a second voltage V2, and outputting the second voltage V2, by the first power converter 200; step S1020 of receiving the second voltage V2 output from the first power converter 200, converting a frequency of the second voltage V2 to generate a third voltage V3 lower than the second voltage V2 and a fourth voltage V4 lower than the first voltage V1 and higher than the third voltage V3, and outputting the third voltage V3 and the fourth voltage V4, by the second power converter 300; step S1030 of receiving the third voltage V3 output from the second power converter 300 to operate, by the controller 500; step S1040 of generating a fifth voltage V5 higher than the first voltage V1 using the first voltage V1 output from the power unit 100 and the fourth voltage V4 output from the second power converter 300 and outputting the generated fifth voltage V5 according to a control signal of the controller 500, by the switching driving unit or switch drive 600; and step S1050 of controlling connection between the power unit 100 and the motor 900 based on the fifth voltage V5 output from the switching driving unit 600, by the switching unit or switch unit 700 positioned between the power unit 100 and the motor 900.

In step S1010, the first power converter 200 may receive and modulate the first voltage V1 output from the power unit 100, and generate and output a second voltage V2 lower than the first voltage V1.

In step S1020, the second power converter 300 may receive the second voltage V2 output from the first power converter 200 and convert the second voltage V2 to generate and output a third voltage V3 lower than the second voltage V2 and a fourth voltage V4 lower than the first voltage V1 and higher than the third voltage V3.

In step S1030, the controller 500 may receive the third voltage V3 output from the second power converter 300 to operate.

In step S1040, the switching driving unit or switch drive 600 may generate a fifth voltage V5 higher than the first voltage V1 using the first voltage V1 output from the power unit 100 and the fourth voltage V4 output from the second power converter 300, and output the generated fifth voltage V5 according to the control signal of the controller 500.

In step S1050, the switching unit 700 connected between the power unit 100 and the motor 900 may control the connection between the power unit 100 and the motor 900 based on the fifth voltage V5 output from the switching driving unit 600.

In the exemplary embodiment, the switching unit 700 may include a back-to-back switch configured to be turned on if the fifth voltage V5 output from the switching driving unit 600 is supplied to the gate terminal of the back-to-back switch to supply the first voltage V1 output from the power unit 100 to the motor 900.

The back-to-back switch may be configured to be turned on when the fifth voltage V5 generated based on the second voltage V2 is greater than or equal to a preset reference voltage.

Accordingly, according to an exemplary embodiment of the present disclosure, in step S1010, the first power converter 200 may generate and output the second voltage V2 within a preset range, and in step S1050, when the fifth voltage V5 generated based on the second voltage V2 is greater than or equal to a preset reference voltage, the back-to-back switch of the switching unit 700 may be turned on.

For example, the predetermined reference voltage of the fifth voltage V5 may be set to a 60V DC voltage generated by summing the 48V DC voltage, which is the first voltage V1 supplied from the power unit 100, and the 12V DC voltage, which is the fourth voltage V4 supplied from the second power converter 300.

For example, when the first power converter 200 generates and outputs a 12V DC voltage which is the second voltage V2, and the switching driving unit 600 generates and outputs a 60V DC voltage which is the fifth voltage V5 based on the second voltage V2, the switching unit 700 may supply the first voltage V1 output from the power unit 100 to the inverter 800 as a voltage difference occurs between the 60V DC voltage which is the fifth voltage V5 supplied to the gate terminal of the back-to-back switch and the 48V DC voltage which is the first voltage V1 supplied from the power unit and the voltage at the gate terminal of the back-to-back switch thus is 12V greater than the threshold voltage.

Here, the voltage output unit 680 according to an embodiment of the present disclosure may include a first output unit 681 configured to output the generated fifth voltage V5 according to the control signal of the controller 500, and the back-to-back switch may include a first switching element configured to be turned on when the fifth voltage V5 output from the first output unit 681 is supplied to the gate terminal of the first switching element.

Accordingly, according to an embodiment of the present disclosure, in step S1040, the voltage generation unit 650 may generate a fifth voltage V5 higher than the first voltage V1 using the first voltage V1 supplied from the first voltage input unit 610 and the fourth voltage V4 supplied from the second voltage input unit 620, the first output unit 681 may output the generated fifth voltage V5 according to the control signal of the controller 500, and in step S1050, if the fifth voltage V5 output from the first output unit 681 is supplied to the gate terminal of the first switching element of the back-to-back switch, the first switching element of the back-to-back switch may be turned on.

The voltage output unit 680 according to an embodiment of the present disclosure may include a second output unit 682 configured to output the generated fifth voltage V5 according to the control signal of the controller 500, and the back-to-back switch may include a second switching element configured to be turned on when the fifth voltage V5 output from the second output unit 682 is supplied to the gate terminal of the second switching element.

Accordingly, according to an embodiment of the present disclosure, in step S1040, the voltage generation unit 650 may generate the fifth voltage V5 higher than the first voltage V1 using the first voltage V1 supplied from the first voltage input unit 610 and the fourth voltage V4 supplied from the second voltage input unit 620, the second output unit 682 may output the generated fifth voltage V5 according to the control signal of the controller 500, and in step S1050, if the fifth voltage V5 output from the second output unit 682 is supplied to the gate terminal of the second switching element of the back-to-back switch, the second switching element of the back-to-back switch may be turned on.

The first switching element and the second switching element may be connected between the power unit 100 and the motor 900, and if the fifth voltage V5 output from the switching driving unit 600 is supplied to the gate terminal of the switching unit 700, the first switching element and the second switching element may be turned on to supply the first voltage V1 output from the power unit 100 to the motor 900.

In this case, the first switching element and the second switching element may be simultaneously turned on or off according to the control signal of the controller 500, and each of the first switching element and the second switching element may be selectively turned on or off according to the control signal of the controller 500.

According to some embodiments of the present disclosure, it is possible to improve space utilization and reduce power consumption and costs by implementing a voltage doubler based on the voltage of input power without using a separate dedicated IC (a pre-driver IC), and driving the switching unit 700 to thereby optimize leakage current.

Further, according to certain embodiments of the present disclosure, when overcurrent occurs, the cut off function of the power unit 100 may be performed to prevent overcurrent, thereby preventing damage to electronic components of the power supply device.

The above description has been presented to enable any person skilled in the art to make and use the technical idea of the disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the disclosure. The above description and the accompanying drawings provide an example of the technical idea of the disclosure for illustrative purposes only. That is, the disclosed embodiments are intended to illustrate the scope of the technical idea of the disclosure. Thus, the scope of the disclosure is not limited to the embodiments shown, but is to be accorded the widest scope consistent with the claims. The scope of protection of the disclosure should be construed based on the following claims, and all technical ideas within the scope of equivalents thereof should be construed as being included within the scope of the disclosure.

What is claimed:

1. A power supply device, comprising:
a first power converter configured to modulate a first voltage output from a power source, and convert a frequency of the first voltage to output a second voltage lower than the first voltage;
a second power converter configured to convert a frequency of the second voltage output from the first power converter to output a third voltage lower than the second voltage and a fourth voltage lower than the first voltage and higher than the third voltage;
a controller configured to receive the third voltage output from the second power converter;
a switch drive configured to generate a fifth voltage higher than the first voltage using the first voltage output from the power source and the fourth voltage output from the second power converter and output the generated fifth voltage according to control of the controller; and
a switch unit connected between the power source and a motor, the switch unit configured to control connection between the power source and the motor in response to the fifth voltage output from the switch drive.

2. The power supply device of claim 1, wherein the switch unit includes a back-to-back switch configured to, in response to the fifth voltage output from the switch drive supplied to a gate terminal of the back-to-back switch, connect between the power source and the motor to supply the first voltage output from the power source to the motor.

3. The power supply device of claim 2, wherein:
the first power converter is configured to generate the second voltage within a preset voltage range, and
the back-to-back switch is configured to connect between the power source and the motor when the fifth voltage generated based on the second voltage is equal to or greater than a preset reference voltage.

4. The power supply device of claim 2, wherein the switch drive includes:
a first voltage input configured to receive the first voltage output from the power source;
a second voltage input configured to receive the fourth voltage output from the second power converter;
a voltage generator configured to generate the fifth voltage higher than the first voltage using the first voltage received from the first voltage input and the fourth voltage received from the second voltage input; and
a voltage output configured to output the generated fifth voltage according to the control of the controller.

5. The power supply device of claim 4, wherein the switch drive further includes a first backflow prevention unit connected between the first voltage input and the voltage generator to prevent a backflow of the fifth voltage generated by the voltage generator.

6. The power supply device of claim 4, wherein the switch drive further includes a voltage charger connected between the second voltage input and the voltage generator to charge the fifth voltage generated by the voltage generator.

7. The power supply device of claim 4, wherein the switch drive further includes a second backflow prevention unit connected between the voltage generator and the voltage output to prevent a backflow of the fifth voltage input to the voltage output.

8. The power supply device of claim 7, wherein the switch drive further includes a voltage rectifier connected between the second backflow prevention unit and the voltage output to rectify the fifth voltage generated by the voltage generator and supply the rectified fifth voltage to the voltage output.

9. The power supply device of claim 4, wherein:
the voltage output includes a first output configured to output the generated fifth voltage according to the control of the controller, and
the back-to-back switch includes a first switch element configured to be turned on if the fifth voltage output from the first output is input to a gate terminal of the first switch element.

10. The power supply device of claim 4, wherein:
the voltage output includes a second output configured to output the generated fifth voltage according to the control of the controller, and
the back-to-back switch includes a second switch element configured to be turned on if the fifth voltage output from the second output is input to a gate terminal of the second switch element.

11. The power supply device of claim 1, wherein the first power converter includes a buck converter configured to modulate the first voltage, output as a direct current (DC) voltage, into a positive pulse wave through a switching-type regulator and perform frequency conversion on the first voltage to convert the first voltage into the second voltage lower than the first voltage.

12. The power supply device of claim 1, wherein the second power converter includes a buck converter configured to convert the second voltage, output as a DC voltage, into the third voltage lower than the second voltage through a switching-type regulator.

13. The power supply device of claim 12, wherein the second power converter includes a boost converter configured to convert the third voltage, output as a DC voltage, into the fourth voltage lower than the first voltage and higher than the third voltage through the switching-type regulator.

14. The power supply device of claim 1, further comprising an inverter connected between the switch unit and the motor to convert a voltage output from the switch unit to supply the converted voltage to the motor.

15. The power supply device of claim 14, wherein the controller configured to detect at least one of an operation state for the inverter or an operation state for the motor and generate a control signal according to at least one of the detected operation state for the inverter or the detected operation state for the motor to output the control signal to the switch drive.

16. A power supply method, comprising:
by a first power converter, modulating a first voltage output from a power source and converting a frequency of the first voltage to output a second voltage lower than the first voltage;
by a second power converter, receiving the second voltage output from the first power converter and converting a frequency of the second voltage to output a third voltage lower than the second voltage and a fourth voltage lower than the first voltage and higher than the third voltage;
by a controller, receiving the third voltage output from the second power converter;
by a switch drive, generating a fifth voltage higher than the first voltage using the first voltage output from the power source and the fourth voltage output from the second power converter and outputting the generated fifth voltage according to control of the controller; and
by a switch unit connected between the power source and a motor, controlling connection between the power source and the motor based on the fifth voltage output from the switch drive.

17. The power supply method of claim 16, wherein the controlling of the connection between the power source and the motor comprises, by a back-to-back switch included in the switch unit, in response to the fifth voltage output from the switch drive supplied to a gate terminal of the back-to-back switch, connecting between the power source and the motor to supply the first voltage output from the power source to the motor.

18. The power supply method of claim 17, wherein:
the converting of the frequency of the first voltage to output the second voltage lower than the first voltage comprises, by the first power converter, generating the second voltage within a preset voltage range, and
the controlling of the connection between the power source and the motor comprises, by the back-to-back switch of the switch unit, connecting between the power source and the motor when the fifth voltage generated based on the second voltage is equal to or greater than a preset reference voltage.

19. The power supply method of claim 18, wherein:
the generating of the fifth voltage higher than the first voltage comprises, by a voltage generator, generating the fifth voltage higher than the first voltage using the first voltage received from a first voltage input and the fourth voltage received from a second voltage input and, by a first output, outputting the generated fifth voltage according to the control of the controller, and
the controlling of the connection between the power source and the motor comprises turning on a first switch element of the back-to-back switch if the fifth voltage output from the first output is input to a gate terminal of the first switch element.

20. The power supply method of claim 19, wherein:
the generating of the fifth voltage higher than the first voltage comprises, by the voltage generator, generating the fifth voltage higher than the first voltage using the first voltage received from the first voltage input and the fourth voltage received from the second voltage input and, by a second output, outputting the generated fifth voltage according to the control of the controller, and
the controlling of the connection between the power source and the motor comprises turning on a second switch element of the back-to-back switch if the fifth voltage output from the second output is input to a gate terminal of the second switch element.
